(19) United States
(12) Patent Application Publication
(10) Pub. No.: US 2002/0181491 A1
(43) Pub. Date: Dec. 5, 2002

(54) Dynamic selection of a medium access method in communication networks

(76) Inventor: Alexander Mircescu, Muenchen (DE)

Correspondence Address: STAAS & HALSEY LLP, 700 11TH STREET, NW, SUITE 500, WASHINGTON, DC, 20001, US

(21) Appl. No.: 10/149,194

(22) PCT Filed: Dec. 6, 2000
(86) PCT No.: PCT/DE00/04347

(30) Foreign Application Priority Data
Dec. 9, 1999 (DE) 199 59 436.8

(51) Int. Cl. H04J 1/00; H04B 7/216

(52) U.S. Cl. 370/442; 370/441; 370/480

(57) ABSTRACT

In packet-oriented communications networks, the information to be transmitted is transmitted from the sender to the receiver in the form of packets. In this case, essentially 3 medium access methods (TDMA, FDMA, CDMA) can be used. The prior art permits only static setting of one or a combination of these medium access methods. In order to be able to make better use of network resources, provision is made for a medium access method which takes up the currently least used resource of this transmission device to be set dynamically.

The invention relates to a method in accordance with the precharacterizing part of patent claim 1.

In contemporary packet-oriented communications networks, the information to be transmitted is transmitted from the sender to the receiver by the communications network in the form of packets.

If the routing in the network is performed dynamically, each packet can be routed through the network via a different physical path to reach the receiver. Since the networks have few physical channels (for example a limited number of optical fiber lines), a multiplex technique needs to be used to control a supervised medium access method for the various subscribers to access the shared transmission channel, in order to achieve multiple utilization.

In the prior art, various medium access methods, such as TDMA (Time Division Multiplex Access), FDMA (Frequency Division Multiplex Access), or CDMA (Code Division Multiplex Access), are generally used. All the medium access methods place different demands on the resources of the communications networks.

In the case of the TDMA method, pulsed signals are used as carrier signals. These pulsed signals are offset from one another in time with no overlap. The packets can then be transmitted in these timeslots. Packet-oriented TDMA technology is memory-intensive, however, since the packets need to be buffer-stored several times on their way through the communications network before they reach the receiver. Finally, at the receiver, the packets also need to be stored until all the packets have been received. only then can the message, which is generally distributed over a plurality of packets, be decoded.

In the case of FDMA/WDM methods, the carrier signals are in the form of bandpass signals with a fixed physical bandwidth. They are offset from one another in the frequency range with no overlap. In this case, a plurality of packets can be transmitted at the same time (on different frequencies). This method places great demands on the bandwidth of the physical transmission medium, since an increasing number of bandpass signals increases the bandwidth requirement at the same time.

Finally, in the case of the CDMA method, the carrier signals chosen are time-limited signals whose cross-correlation functions admittedly do not disappear at all times, but always assume only low amplitude values. These quasi-orthogonal carrier functions are often obtained from white noise limited by low pass filtering. As in the case of the FDMA method, the CDMA method also allows packets to be transmitted at the same time using the medium in question. In contrast to the FDMA method, however, this is done in the same physical frequency range. This means that the CDMA method can place lesser demands on the physical bandwidth of the transmission medium. However, this entails the price of increased complexity in the data-processing components of the communications network, because decoding the signals using auto-correlation functions requires not inconsiderable processing complexity.

To date, the medium access method has been selected statically. This means that, when the communications network and its components are started up, the relevant medium access method is set permanently. Acting as a criterion for this is the physical form of the communications network and of its components (i.e. routers, terminals, etc.). This static condition underlies the dynamic influence of the current resource utilization, which influence can result in the currently available processing, storage and transmission power fluctuating over time. The resources in the network thus have different processing, transmission and storage powers.

The dynamically occurring load changes in the network components are not taken into account for a static selection, however, which means that, in adverse cases (e.g. when there is a high level of resource utilization), longer transmission times have to be accepted. Although modern packet-oriented communications networks based on dynamic routing (such as TCP/IP or UMTS networks) allow different medium access methods (TDMA, FDMA, CDMA) to be combined, a problem in this regard is that the combination is in the form of a static selection in this case too.

The invention is based on the object of indicating a way in which it is possible to use simple means to counter the changing conditions in terms of available resources in the network.

The invention is achieved, on the basis of the precharacterizing part of patent claim 1, by the features specified in the characterizing part.

The advantage of the invention can be seen, in particular, in the concept of dynamic selection and of the resultant dynamic adjustment between the different medium access methods. Accordingly, it is possible to achieve optimum utilization of the individual components (e.g. routers) in the communications network and hence to minimize transmission times. Depending on the power and utilization level of the various components in the communications networks, this dynamic alignment of the medium access method can set the best transmission type in terms of transmission time.

By evaluating the static information about the power of the resources and the dynamic information about resource utilization, it is possible to switch dynamically between the different access methods section by section. This means that the FDMA medium access will be preferable in the cases in which there is a large amount of bandwidth available, and the CDMA medium access method will be preferable in the cases where there is a large amount of data processing resources available.

Advantageous developments of the invention are specified in the subclaims.

The invention is explained in more detail below using an exemplary embodiment which is illustrated in the figures, in which:

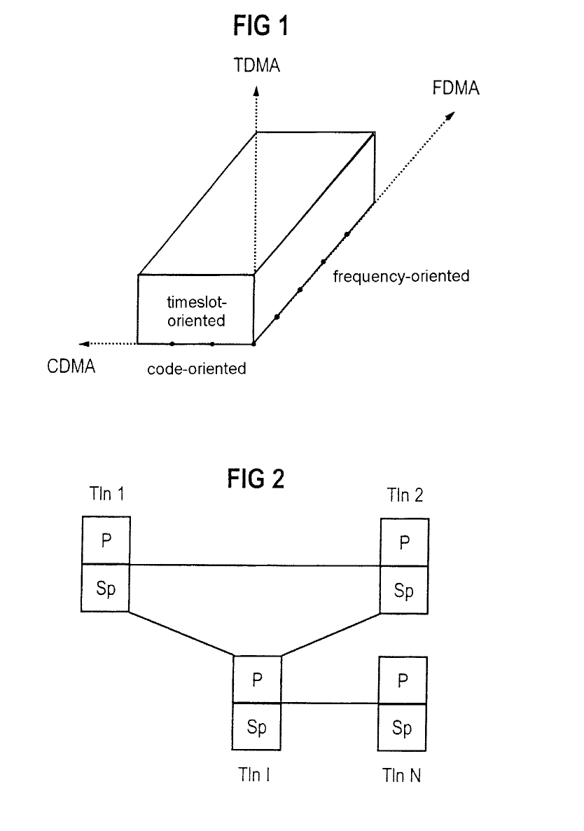

FIG. 1 shows the medium access methods FDMA, TDMA, CDMA,

FIG. 2 shows a communications network with subscribers, processors, and memories,

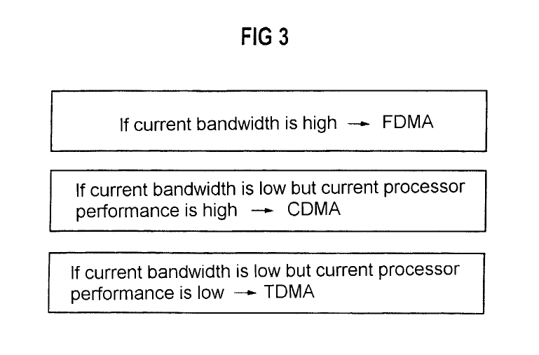

FIG. 3 shows a selection table for the multiplex method.

FIG. 1 shows the known medium access methods TDMA, FDMA and CDMA once more with their characteristics. The FDMA medium access method is frequency-oriented and places great demands on the bandwidth of the communications system. The CDMA medium access method is code-oriented and needs a smaller amount of physical bandwidth in the communications system in order to achieve a high throughput; instead, the data processing components in the communications network need to be high-powered, however, in order to use the calculations of the auto- and cross-correlation functions to decode the associated signal stream. The TDMA medium access method is timeslot-oriented and requires a large amount of storage capacity. The three said medium access methods TDMA, FDMA and CDMA can also be combined with one another in order to increase the multiple utilization of the physical transmission medium.

FIG. 2 shows a typical communications network. The communications network is designed for transmitting voice, data, video and comprises subscribers TLN1, TLN2, . . . TLNi . . . TLNn which have processing resources (processors P) and memory resources (SP) available locally and are networked to one another by means of physical transmission paths (optical fiber, coaxial cable, two-wire line, air, radio relay, satellite link, optical radio relay, optical satellite link, . . . etc.) having a particular bandwidth. The medium access method FDMA affords a very high throughput in information transmission, particularly when combined with CDMA. The combination can be used to take account of the peculiarities of the communications network.

If, by way of example, the subscriber TLN1 wants to send the subscriber TLNi messages in the form of Internet packets, then these can take different paths in the communications network. The physical connection paths incorporate routers—not shown in more detail in FIG. 2—which are respectively interconnected. The subscriber TLN1 breaks down the message which is to be sent into individual IP packets which are each numbered consecutively before they are sent to the first router. The first router receives the IP packets and supplies them to all the routers connected to it for the purpose of broadcasting. These routers, for their part, receive the IP packets and pass them to further routers connected to them. However, the IP packets are forwarded by a router only if it knows the received and its resources (processors, memory, bandwidth) allow it to do so. Otherwise the IP packets are rejected. The subscriber

TLNi puts the arriving IP packets back into the correct order and rejects IP packets which have arrived more than once.

If the medium access method is selected on the basis of the static information about the resource power, the overlap in the dynamic effects can mean that the selected method proves to be disadvantageous in a particular time period if, by way of example, a CDMA medium access method is used and the processors are heavily loaded. Since packet-oriented networks such as TCP/IP or UMTS allow all of said access methods, the following approach to selecting the multiplex technique is chosen in the present case:

First, the sending subscriber TLN1 ascertains the available resources. These resources are generally known to the operating system. The corresponding circumstances are shown in table form in FIG. 3.

If, by way of example, the transmission medium thus currently has a large amount of bandwidth available (for example because the physical medium provides this bandwidth and because the amount of message traffic is so small that the user can use a large amount of said bandwidth), message transmission from the sending subscriber TLN1 to the receiving subscriber TLNi is controlled using the FDMA medium access method. This allows the full physical bandwidth of the transmission medium to be utilized, so that the transmission time can be minimized.

If the transmission medium's current amount of physical bandwidth is too small, but the current available processing power of the processors P is high (for example because processors which have a high level of performance for this application are used and, at the time under consideration, are processing so few processes that the subscriber can make a lot of use of them), message transmission is performed using the CDMA medium access method. In this case, on the one hand, the transmission time increases, because the amount of communications bandwidth is smaller than in the case of the FDMA medium access method. On the other hand, this effect is somewhat lessened by the fact that the CDMA medium access method also involves packets being transmitted at the same time, and decoding is performed quickly by the powerful processors.

If, finally, both the transmission medium's current amount of bandwidth and the current processing power of the processors P available to the user are low, as TDMA medium access method is chosen. In this case, no IP packets can be sent at the same time, which means that the transmission time increases further. The receiving subscriber TLNi needs to buffer-store the easily decodable IP packets until all the IP packets needed for producing the message in full have been received. This makes heavy use of the memory resources SP, however. Despite the comparatively very long transmission time, the TDMA medium access method is advantageous in this case, because transmission, albeit with a small amount of bandwidth, becomes possible immediately. If this flexibility were not provided, which means that the user would certainly require a particular bandwidth which is not available at the time under consideration, his transmission request would be put into a queue to wait until the bandwidth is available. Accordingly, the transmission time would increase even more.

Up to now, the invention has been explained with reference to an end to end connection. However, the invention is implemented section by section. Thus, by way of example, the TDMA medium access method can be set from the sending subscriber TLN1 to the first router. From this router to the next router, a different medium access method e.g. CDMA, can be set. The criterion for this is just the resources in the first, i.e. sending, router, etc. This means that the IP packets have been subjected to different medium access methods several times by the time they reach the receiving subscriber TLNi. With a long connection between subscriber TLN1 and subscriber TLNi, a significant speed advantage is obtained, since an optimum medium access method has always been chosen.

The invention described above is preferably used in communications networks in which information is routed dynamically from a sending subscriber to a receiving subscriber. The invention is not limited just to communications networks with dynamic routing, however. Thus, the invention can also be applied to ATM communications networks. In this case, a signaling connection is first set up which is likewise routed via a plurality of routers. The ATM cells carrying the information which is to be transmitted are then subsequently routed via this connection for the purposes of a virtual connection. In this context, the medium access method can be optimized section by section, that is to say from router to router, for the purposes of the invention.

1. A method for selecting the medium access method in a communications network, using
information exchanged between at least two transmission devices, possibly via a plurality of further transmission devices, on the basis of a further plurality of medium access methods (FDMA, TDMA, CDMA), with each medium access method taking up characteristic resources in each of the transmission devices,
characterized
in that, on the basis of ascertainment of all the available resources in a transmission device, the medium access method which takes up the currently least used resource of this transmission device is set selectively.

2. The method as claimed in claim 1,
characterized
in that a medium access method is set section by section between two respective transmission devices.

3. The method as claimed in claim 1 or 2,
characterized
in that the transmission devices are in the form of subscriber terminals (TLN1, TLNi) or router devices arranged between said subscriber terminals.

4. The method as claimed in claim 1 to 3,
characterized
in that the communications network is of packet-oriented design.

5. The method as claimed in one of the preceding claims,
characterized
in that the information is exchanged on the basis of an Internet protocol (TCP/IP) or a protocol (UMTS) used for mobile radio.

6. The method as claimed in one of claims 1 to 5,
characterized
in that the information is exchanged on the basis of an asynchronous transfer mode (ATM).

7. The method as claimed in one of the preceding claims,
characterized
in that the medium access methods is in the form of an FDMA medium access method (FDMA), a TDMA medium access method (TDMA), or a CDMA medium access method (CDMA).
